(19) United States
(12) Patent Application Publication
(10) Pub. No.: US 2018/0030169 A1
(43) Pub. Date: Feb. 1, 2018

(54) THERMORESPONSIVE POLYMERS

(71) Applicant: PHILLIPS 66 COMPANY, Houston, TX (US)

(72) Inventors: Paula Delgado, Bartlesville, OK (US); Amit Palkar, Bartlesville, OK (US)

(73) Assignee: PHILLIPS 66 COMPANY, Houston, TX (US)

(21) Appl. No.: 15/662,943

(22) Filed: Jul. 28, 2017

Related U.S. Application Data
(60) Provisional application No. 62/368,467, filed on Jul. 29, 2016.

(51) Int. Cl. C08F 20/36; C08F 20/56

(52) U.S. Cl. CPC C08F 20/36; C08F 20/56

(57) ABSTRACT

A polymer comprising

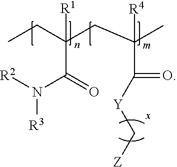

In this polymer R1 and R4 can be independently selected from the group consisting of H and alkyl groups; R2 and R3 can be independently selected from the group consisting of H, alkyl, olefinic, aromatic, heterocyclic, halogen, ammonium, nitroxides, nitrates, nitrite amides, amines, esters, ethers, carboxylic acids, acyl chlorides, alcohols, nitriles, phosphates, phosphonates, sulfates, sulfonates, sulfide, sulfite, thiol, and combinations thereof; Y can be selected from the group consisting of O, N and S; Z can be a hydrogen bonding group that is at least triple bonded or higher and X are methylene groups.

### CROSS-REFERENCE TO RELATED APPLICATIONS

This application is a non-provisional application which claims the benefit of and priority to U.S. Provisional Application Ser. No. 62/368,467 filed Jul. 29, 2016, entitled “Thermoresponsive Polymers,” which is hereby incorporated by reference in its entirety.

### STATEMENT REGARDING FEDERALLY SPONSORED RESEARCH OR DEVELOPMENT

None.

### FIELD OF THE INVENTION

This invention relates to thermoresponsive polymers.

### BACKGROUND OF THE INVENTION

Thermoresponsive polymers are polymers that exhibit a drastic and discontinuous change of the physical properties with temperature.

There exists a need for thermoresponsive polymers that can be formed through temperature changes.

### BRIEF SUMMARY OF THE DISCLOSURE

A polymer comprising

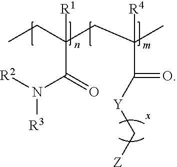

In this polymer R1 and R4 can be independently selected from the group consisting of H and alkyl groups; R2 and R3 can be independently selected from the group consisting of H, alkyl, olefinic, aromatic, heterocyclic, halogen, ammonium, nitroxides, nitrates, nitrite amides, amines, esters, ethers, carboxylic acids, acyl chlorides, alcohols, nitriles, phosphates, phosphonates, sulfates, sulfonates, sulfide, sulfite, thiol, and combinations thereof; Y can be selected from the group consisting of O, N and S; Z can be a hydrogen bonding group that is at least triple bonded or higher and X are methylene groups.

A polymer comprising

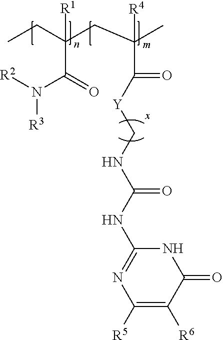

In this polymer R1 and R4 can be independently selected from the group consisting of H and alkyl groups; R2 and R3 can be independently selected from the group consisting of H, alkyl, olefinic, aromatic, heterocyclic, halogen, ammonium, nitroxides, nitrates, nitrite amides, amines, esters, ethers, carboxylic acids, acyl chlorides, alcohols, nitriles, phosphates, phosphonates, sulfates, sulfonates, sulfide, sulfite, thiol, and combinations thereof; Y can be selected from the group consisting of O, N and S; R5 and R6 can be independently selected from the group consisting of alkyl, olefinic, heterocyclic, halogens, ammonium, carboxylic, amines, esters, amides and combinations thereof; and X are methylene groups.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts a NMR comparison of a thermoresponsive polymer made with an organic solvent versus one made with water.

FIG. 2 depicts a ¹H NMR of 2-(3-(4-methyl-6-oxo-1,6-dihydropyrimidin-2-yl)ureido)ethyl acrylate.

FIG. 3 depicts a ¹³C NMR of 2-(3-(4-methyl-6-oxo-1,6-dihydropyrimidin-2-yl)ureido)ethyl acrylate.

FIG. 4 depicts a reaction scheme.

FIG. 5 depicts a reaction scheme.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

A polymer comprising

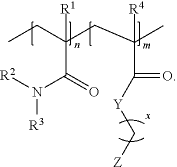

In this polymer R1 and R4 can be independently selected from the group consisting of H and alkyl groups; R2 and R3 can be independently selected from the group consisting of H, alkyl, olefinic, aromatic, heterocyclic, halogen, ammonium, nitroxides, nitrates, nitrite amides, amines, esters, ethers, carboxylic acids, acyl chlorides, alcohols, nitriles, phosphates, phosphonates, sulfates, sulfonates, sulfide, sulfite, thiol, and combinations thereof; Y can be selected from the group consisting of O, N and S; Z can be a hydrogen bonding group that is at least triple bonded or higher and X are methylene groups from 0 to 20 carbons. It is theorized that such a polymer would be a thermoresponsive polymer. It is also theorized that such a polymer can be a water soluble thermoresponsive polymer.

In one embodiment, the repeat units of the n polymer can be from n=1 to n=100,000,000. In another embodiment, the repeat units of the m polymer can be from m=1 to m=100,000,000.

In one embodiment Z can be selected from

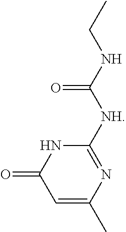

In another embodiment Z can be selected, from the group consisting of

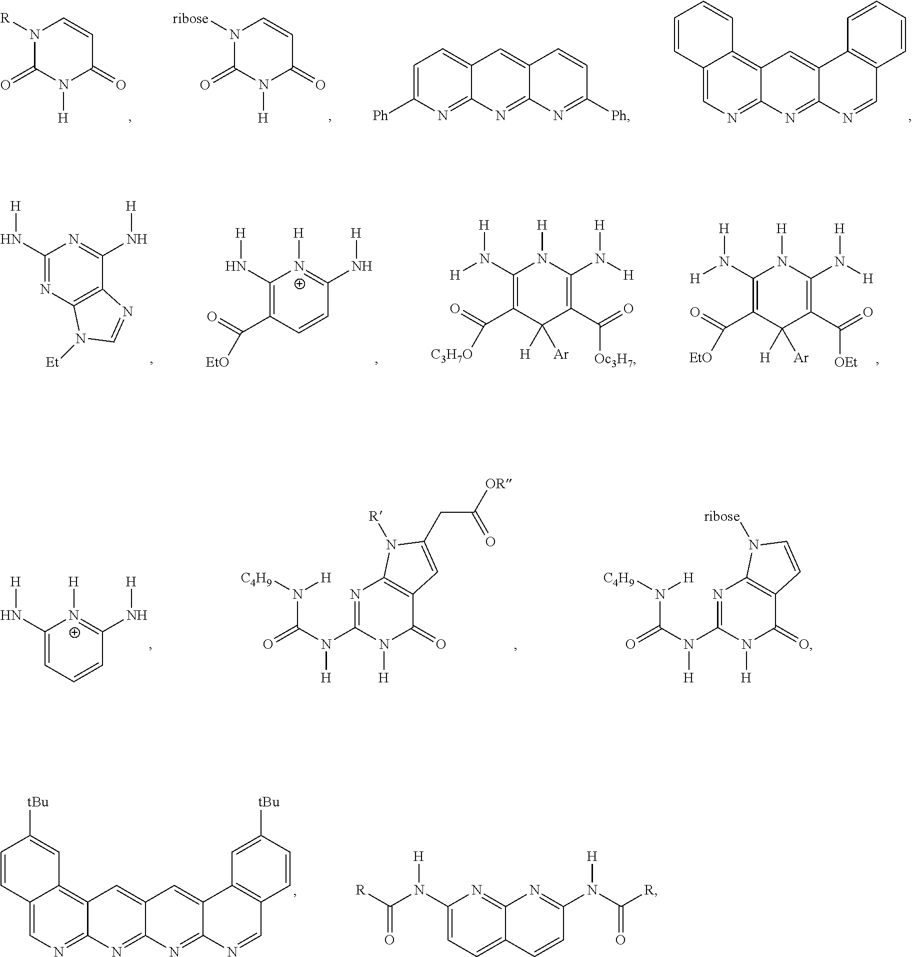

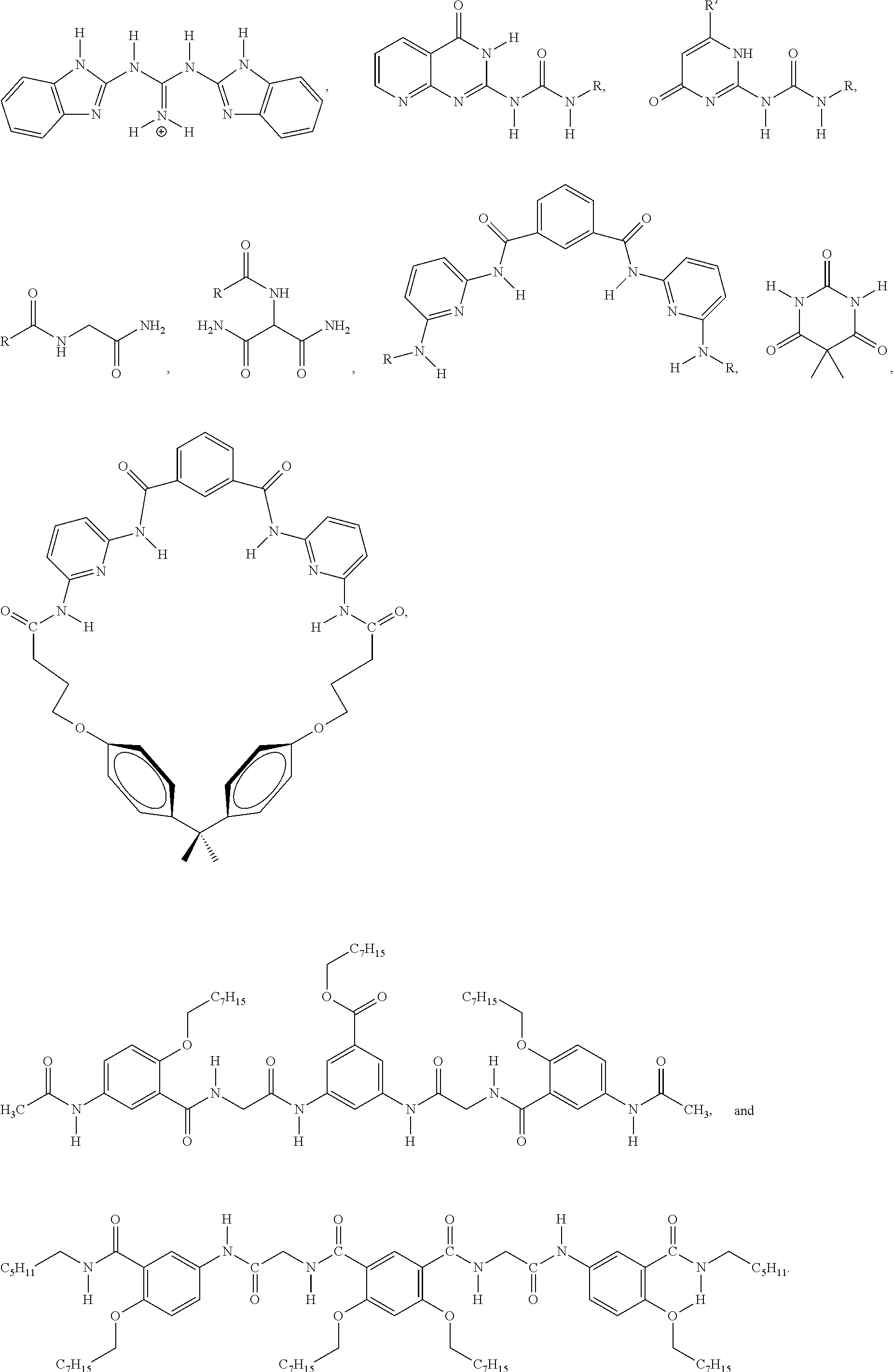

The number of methylene groups of X can range anywhere from about 0 to about 20, in other embodiments X can range anywhere from 0 to 25, 0 to 20, 0 to 15, 0 to 10 even from 0 to 5.

In one embodiment, R2 and R3 can be independently selected from the group consisting of H, C₁-C₁₀ alkyls, C₁-C₁₀ olefinics, aromatic, heterocyclic, halogen, ammonium, nitroxides, nitrates, nitrite amides, amines, esters, ethers, carboxylic acids, acyl chlorides, alcohols, nitriles, phosphates, phosphonates, sulfates, sulfonates, sulfide, sulfite, thiol, and combinations thereof.

The polymer can have an upper critical solubility temperature. An upper critical solubility temperature is the critical temperature above which the components of a mixture are miscible in all proportions.

The polymer can be made using any known method to make the polymer. One such method involves by mixing

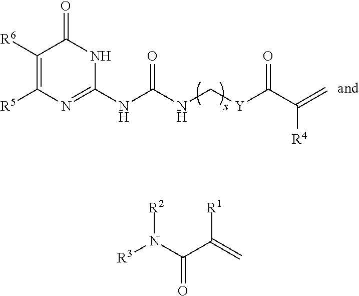

in the presence of a solvent to form a monomer solution. An initiator is then added to the monomer solution to form the polymer. In this method, R3 and R6 can be independently selected from the group consisting of H and alkyl groups; R4 and R5 can be independently selected from the group consisting of H, alkyl, olefinic, aromatic, heterocyclic, halogen, ammonium, nitroxides, nitrates, nitrite amides, amines, esters, ethers, carboxylic acids, acyl chlorides, alcohols, nitriles, phosphates, phosphonates, sulfates, sulfonates, sulfide, sulfite, thiol, and combinations thereof; Y can be selected from the group consisting of O, N and S; R5 and R6 can be independently selected from the group consisting of alkyl, olefinic, heterocyclic, halogens, ammonium, carboxylic, amines, esters, amides and combinations thereof; and X are methylene groups.

Upon completion of polymerization, the polymer exhibits thermoresponsive behavior through hydrogen bonding in water. When bonded together the hydrogen bonding groups can be either bonded by complementary hydrogen bonding groups or could be self-complementary bonded.

In one embodiment, the average molecular weight of the polymer is greater than 50,000. In other embodiments, the average molecular weight is greater than 60,000, 62,000, 65,000, 70,000, 71,000, 75,000 even greater than 80,000.

In one embodiment the solvent can be an organic solvent. Non-limiting examples of solvents that can be used include dimethyl sulfoxide, dimethyl formamide, ethyl acetate, methanol, dioxane, tetrahydrofuran, acetone, methylene chloride, chloroform and toluene.

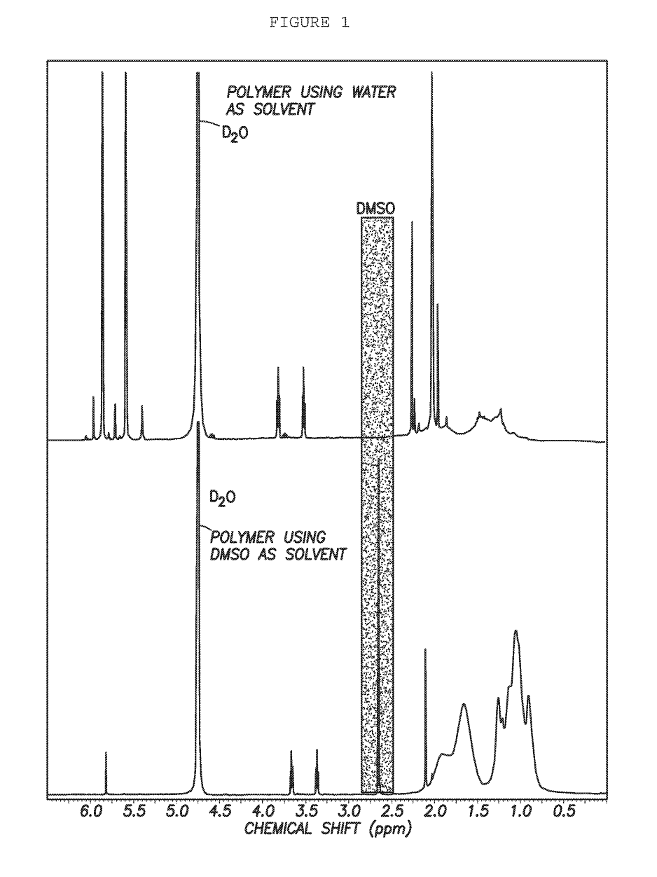

In other embodiments, the solvent can be water inorganic salts, such as electrolyte solutions. Any conventionally known inorganic salts can be used. FIG. 1 depicts a NMR comparison of using an organic solvent as a solvent versus using water. As shown in the Figure, the organic solvent of dimethyl sulfoxide can be difficult to remove from the polymer and can result in a polymer with an organic solvent contaminant. When the solvent is water it is envisioned that the purification step can be optional.

In another embodiment the initiator can be an addition-type initiator, such as radical initiators. Non-limiting examples of addition-type initiators that can be used include, azo initiators, azobisisobutyronitriles, peroxides, persulfates and redox systems. In one embodiment the initiator can also be a UV initiator. Non-limiting examples of peroxide initiators include: persulfate salts, hydrogen peroxide, alkyl peroxide, alkyl peroxyesters, peroxydicarbonates, hydroperoxides and combinations thereof. Non-limiting examples of azo initiators include: 4,4′-azobis(4-cyanovaleric acid), 4,4′-azobis-(4-cyanopentanoic acid), 2,2′-azobis(2-methylpropionamidine)dihydrochloride, 2,2′-azobis[2-(2-imidazolin-2-yl)propane]dihydrochloride, 2,2′-azobis[N-(2-carboxyethyl)-2-methylpropionamidine] tetrahydrate, 2,2′-azobis[2-(2-imidazolin-2-yl)propane], 2,2′-azobis[2-methyl-N-(2-hydroxyethyl)propionamide], 2,2′-azobis-(2-amidinopropane) dihydrochloride, 2,2′-azobis(N,N′-dimethylene isobutyramidine) dihydrochloride, 2,2′-zobis(N,N′-dimethylene isobutyramidine), 2,2′-azobis-(isobutyramide)dehydrate, 2,2′-azobis-(N-ethylamidinopropane hydrochloride), 2,2′-azobis-(N,N′-dimethyleneamidinopropane hydrochloride), 2,2′-azobis(2-propane-2-carboxylic acid), 2,2′-azobis-(2-methyl-N-(2-hydroxyethyl))propionamide, 2,2′-azobis-[2-methyl-N-(1,1-bis(hydroxymethyl)]propionamide, 2,2′-azobis-[2-methyl-N-(1,1-bis(hydroxymethyl)-2-hydroxyethyl)]propionamide and combinations thereof.

The reaction time to create the polymers can range from less than ten minutes, less than 15 minutes, less than half an hour, less than an hour, less than 2 hours, less than 4 hours, or even less than 24 hours. The reaction time is theorized to be dependent upon the starting materials.

In one embodiment azobisisobutyronitrile can be dissolved in the same or different solvent in molar ratios of 1:5 to 1:10000 with respect to the molar concentration of the monomer solution to form the thermoresponsive polymer. Examples of ranges in molar ratios from 1:5, 1:10, 1:25, 1:50 1:75, 1:100, 1:500, 1:1000, 1:1500, 1:2000, 1:2500, 1:3000, 1:3500, 1:4000, 1:4500, 1:5000, 1:5500, 1:6000, 1:6500, 1:7000, 1:7500, 1:8000, 1:8500, 1:9000, 1:9500, 1:10000 or any range in between the numbers given. This thermoresponsive polymer can then be optionally degassed at ambient temperature.

In one embodiment the monomer solution is heated to a temperature greater than 30° C., 35° C., 40° C., 45° C., 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., or even greater than 200° C. The heating of the monomer solution can occur either by directly heating the monomer solution, incorporating the monomer solution into another solution with a greater temperature than the monomer solution, or any other method known of heating the monomer solution.

In another embodiment the mixing of the monomer solution occurs at an elevated temperature. Examples of the temperature in which the monomer solution can be mixed in include temperature greater than 30° C., 35° C., 40° C., 45° C., 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., or even greater than 200° C. The mixing of the monomer solution at an elevated temperature can occur by heating one component of the monomer solution, heating multiple components of the monomer solution or any other known method of mixing the monomer solution at an elevated temperature. This monomer solution can then be optionally degassed at room temperature or the temperatures above. The reaction time can be any time necessary for conversion of monomers,

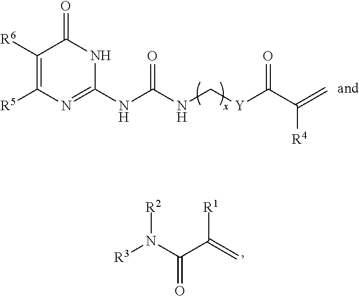

within the monomer solution to polymers. Additionally, the reaction time can be any time necessary for the reaction of monomers,

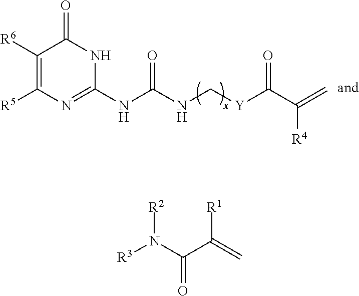

to take place.

In one embodiment the thermoresponsive polymer is purified in a polar solvent, such as alcohol. Examples of type of polar solvents that can be used include ethanol, methanol, acetone, water, tetrahydrofurane, ether and ethyl acetate.

In one embodiment the ratio of 2-(3-(4-methyl-6-oxo-1,6-dihydropyrimidin-2-yl)ureido)ethyl methacrylate to methacrylamide in monomer solution ranges in mol percentage from 0.01:99.99, 0.05:99.5, 1:99, 2:98, 3:97, 4:96, 5:95, 6:94, 7:93, 8:92, 9:91, 10:90, 11:89, 12:88, 13:87, 14:86, 15:85, 16:84, 17:83, 18:82, 19:81, 20:80, 21:79, 22:78, 23:77, 24:76, 25:75, 26:74, 27:73, 28:72, 29:71, 30:70, 31:69, 32:68, 33:67, 34:66, 35:65, 36:64, 37:63, 38:62, 39:61, 40:60, 41:59, 42:58, 43:57, 44:56, 45:55, 46:54, 47:53, 48:52, 49:51, 50:50 or any range in between the numbers given.

There are a variety of methods in which the thermoresponsive polymer can be incorporated into the wastewater. In one method it is possible that the thermoresponsive polymer is directly added into the wastewater. In another method, the thermoresponsive polymer is dissolved in a chemical solution, which solubilizes the polymer, and then incorporated in the wastewater. In one example the chemical is Sodium Chloride (NaCl) solution. The amount of chemical added can be from about 0.0001 wt % to about 30 wt %, or from any amount greater than about 0.0005 wt %, 0.001 wt %, 0.005 wt %, 0.01 wt %, 0.05 wt %, 0.1 wt %, 0.5 wt %, 1 wt %, to any amount smaller than about 25 wt %, 20 wt %, 15 wt %, 10 wt %, or even about 5 wt %.

Examples of wastewater can be from refineries such as desalter effluent, from paper making facilities, from municipal water treatment facilities or any other facility that produces wastewater. Wastewater can be broadly defined as any aqueous environment that has high inorganic salts content (broadly defined as greater than or equal to 100 ppm, greater than or equal to 200 ppm or around 1000 ppm), suspended solids (≦500 ppm), hydrocarbons (as free and/or emulsified oil), other organics and inorganics or combinations thereof.

The following examples of certain embodiments of the invention are given. Each example is provided by way of explanation of the invention, one of many embodiments of the invention, and the following examples should not be read to limit, or define, the scope of the invention.

### Example 1

The amounts of 2-(3-(4-methyl-6-oxo-1,6-dihydropyrimidin-2-yl)ureido)ethyl methacrylate (MAUPy) and methacrylamide (MAAm) listed in Table 1, along with 1.2 mL of dimethyl sulfoxide solvent, were added to a 50 mL reaction flask equipped with a stir bar. The chemicals started to dissolve after immersing the flask in a 70° C. oil bath under strong stirring. When the solution was homogenous, the system was degassed by freeze-pump thaw or by bubbling an inert gas. After degassing, the solution was again immersed into the 70° C. oil bath to preserve the monomers in solution. In a separate small vial, the corresponding amount of azobisisobutyronitrile (AIBN) initiator was dissolved in 100 μL of dimethyl sulfoxide solvent (DMSO), and subsequently degassed. The polymerization started after the addition of the azobisisobutyronitrile solution to the reaction flask at 70° C. under an inert atmosphere. These conditions were maintained for 4 h. The polymerization was then quenched by exposing the reaction mixture to air at room temperature or by adding a radical inhibitor. Polymers were purified by 24 h of stirring in methanol (100 mL) followed by 24 h of dialysis in methanol (3000 g mol⁻¹ cut off).

TABLE 1

| | MAAm | | | |
|---|---|---|---|---|
| Sample | ratio | MAUPy amount | MAAm amount | AIBN amount |
| Poly(MAUPy)-100 | 0 | 100 mg, | | 0.117 mg, |
| | | 3.6 × 10−1 mmol | | 7.1 × 10−4 mmol |
| Poly(MAUPy-MAAm)-70 | 30 | 100 mg, | 13.01 mg, | 0.17 mg, |
| | | 3.6 × 10−1 mmol | 0.15 mmol | 1.0 × 10−3 mmol |
| Poly(MAUPy-MAAm)-50 | 50 | 100 mg, | 30.37 mg, | 0.23 mg, |
| | | 3.6 × 10−1 mmol | 0.36 mmol | 1.4 × 10−3 mmol |
| Poly(MAUPy-MAAm)-20 | 80 | 100 mg, | 121.48 mg, | 0.59 mg, |
| | | 3.6 × 10−1 mmol | 1.43 mmol | 3.6 × 10−3 mmol |
| Poly(MAUPy-MAAm)-10 | 90 | 100 mg, | 273.32 mg, | 1.17 mg, |
| | | 3.6 × 10−1 mmol | 3.24 mmol | 7.1 × 10−3 mmol |
| Poly(MAUPy-MAAm)-5 | 95 | 100 mg, | 577.01 mg, | 2.34 mg, |
| | | 3.6 × 10−1 mmol | 6.78 mmol | 1.4 × 10−2 mmol |
| Poly(MAUPy-MAAm)-2 | 98 | 100 mg, | 1.49 g, | 5.86 mg, |
| | | 3.6 × 10−1 mmol | 17.49 mmol | 3.6 × 10−2 mmol |

Table 2 depicts the solubility of different samples of Poly(MAUPy-MAAm)

TABLE 2

| | | Solubility | Solubility in water |
|---|---|---|---|
| | MAAm | in water | at 175° F. with |
| Sample | ratio | 175° F. | 1 wt % NaCl |
| Poly(MAUPy-MAAm)-70 | 30 | No | Yes |
| Poly(MAUPy-MAAm)-50 | 50 | No | Yes |
| Poly(MAUPy-MAAm)-20 | 80 | No | Yes |
| Poly(MAUPy-MAAm)-10 | 90 | No | Yes |
| Poly(MAUPy-MAAm)-5 | 95 | Yes | Yes |
| Poly(MAUPy-MAAm)-2 | 98 | Yes | Yes |

### Example 2

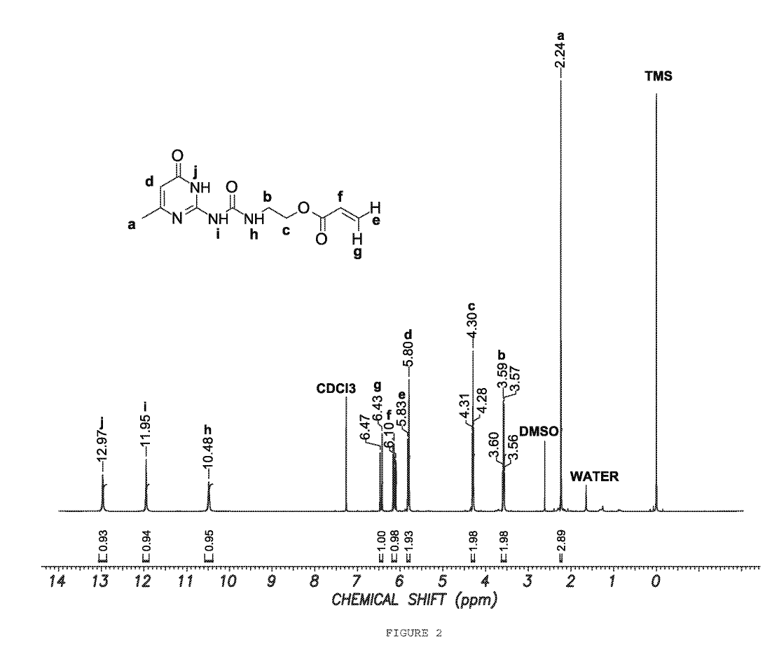

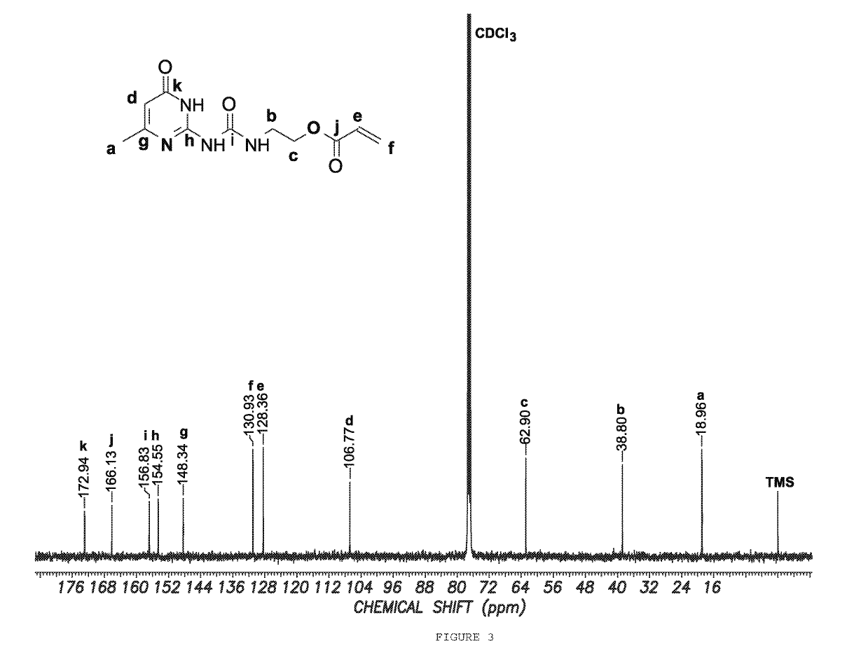

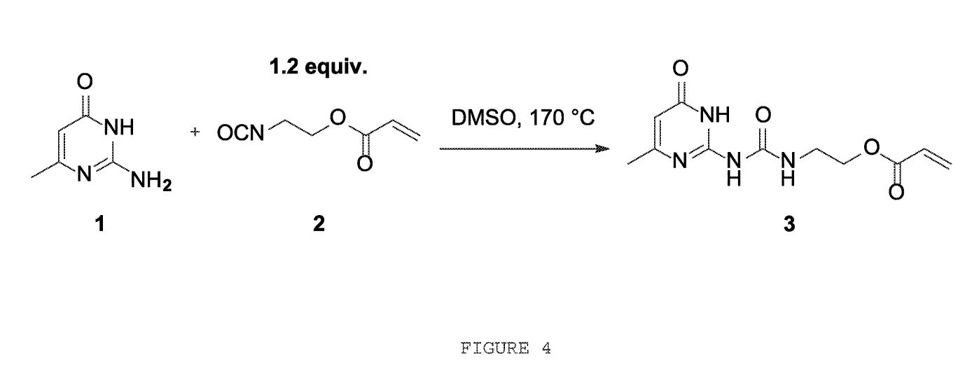

Synthesis of 2-(3-(4-methyl-6-oxo-1,6-dihydropyrimidin-2-yl)ureido)ethyl acrylate (AUPy): To a round bottom flask equipped with a magnetic stir bar 6-methyl isocytosine (4.0 g, 32 mmol) and 50 mL dimethyl sulfoxide solvent were added. In order to dissolve the 6-methyl isocytosine in the DMSO, the flask was sealed with a septum and heated to 170° C. using an oil bath. Upon dissolution, the oil bath was removed and 2-isocyanatoethyl acrylate (4.8 mL, 38 mmol) was added via syringe. The reaction was then quenched by cooling the reaction flask in a 2-propanol/CO₂₍ₛ₎ bath. After 5-10 min of cooling the reaction flask was thawed using an ambient temperature water bath and the white solid was washed 3×1000 mL with cold water (stirring for ≧60 min per wash), filtered, and dried at reduced pressure overnight to yield 7.57 g of white powder (89% yield). FIG. 2 depicts the H NMR of the AUPy and FIG. 3 depicts the C NMR of the AUPy. FIG. 4 depicts the reaction scheme for this reaction.

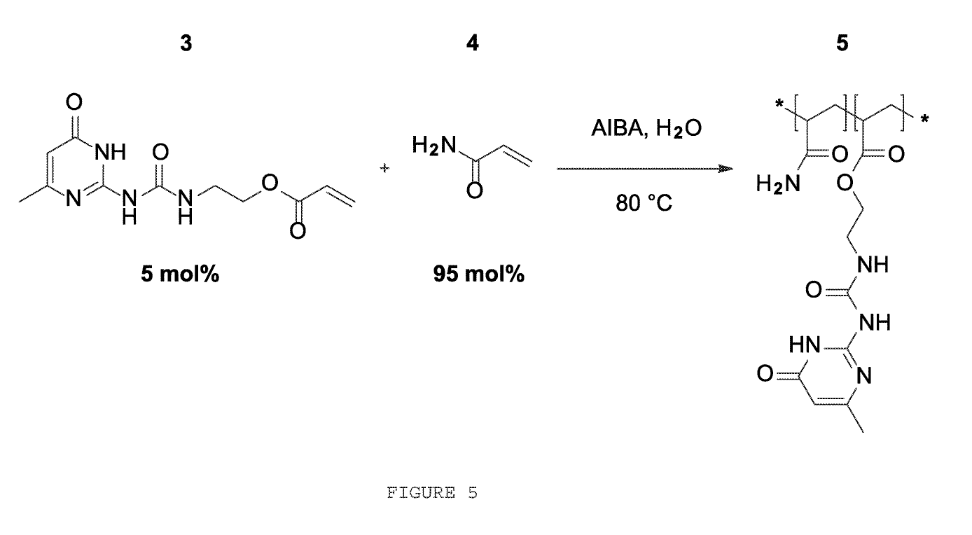

Synthesis of Poly[acrylamide-co-2-(3-(4-methyl-6-oxo-1,6-dihydropyrimidin-2-yl)ureido)ethyl acrylate], poly(AUPy-AAm)-5: To a 25 mL round bottom flask equipped with a magnetic stirrer, 0.20 g AUPy, 1.02 g acrylamide (AAm), 0.05 g sodium carbonate, and 12 mL water was added. The flask was immersed in an 80° C. oil bath to dissolve the solids and the mixture was degassed by argon flow for 30 minutes. In a 2 mL vial, 0.0065 g 2,2′-Azobis(2-methylpropionamidene) dihydrochloride (AIBA) was added to 0.2 mL water. The AIBA solution was degassed by argon flow and transferred to the round bottom flask using a 1 mL syringe to initiate the polymerization. This method generates poly(AUPy-AAm)-5, a copolymer that consists of 95 mol % AAm and 5 mol % AUPy and with a monomer to initiator ratio of 600 to 1. FIG. 5 depicts the reaction scheme for this reaction.

The reaction mixture was purified by stirred at 500 rpm for 4 hours, and an opaque and viscous solution was obtained. The polymer was precipitated from solution as white solids by slowly adding equal volume of acetone to reaction mixture. The polymer-acetone-water slurry was separated by centrifugation (5000 rpm, 5 min), the liquid was decanted, and the resulting solid material was dried at reduced pressure to yield 1.19 g of white powder (97% yield).

### Example 3

Random copolymer of 5 mol % of 2-(3-(4-methyl-6-oxo-1,6-dihydropyrimidin-2-yl)ureido)ethyl methacrylate and 95 mol % of methacrylamide were synthesized in water and inorganic salts and purified with perchlorate (sample DI-Perchlorate), synthesized in water and inorganic salts and purified with hydrochloric acid (sample DI-HCl), and synthesized in DMSO and washed in water (sample DMSO-DI). The apparent viscosity, specific viscosity and weight average molecular weight are shown in Table 3.

TABLE 3

| | Apparent Viscosity | Specific Viscosity | |
|---|---|---|---|
| Polymer | mPa-s | (a.u.) | Mw (g/mol)² |
| DI-Perchlorate | 1.051 ± 0.016 | 0.289 | 62,200 ± 6,000 |
| DI-HCl | 1.060 ± 0.014 | 0.300 | 65,600 ± 5,000 |
| DMSO-DI | 1.074 ± 0.002 | 0.317 | 71,000 ± 1,000 |

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A polymer comprising: 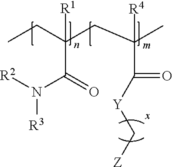
wherein: R1 and R4 are independently selected from the group consisting of H and alkyl groups;
R2 and R3 are independently selected from the group consisting of H, alkyl, olefinic, aromatic, heterocyclic, halogen, ammonium, nitroxides, nitrates, nitrite amides, amines, esters, ethers, carboxylic acids, acyl chlorides, alcohols, nitriles, phosphates, phosphonates, sulfates, sulfonates, sulfide, sulfite, thiol, and combinations thereof;
Y is selected from the group consisting of O, N and S;
Z is a hydrogen bonding group that is at least triple bonded or higher and
X are methylene groups.

2. The polymer of claim 1, wherein Z is

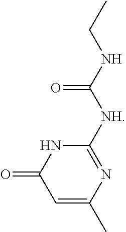

3. The polymer of claim 1, wherein Z is selected from the group consisting of:

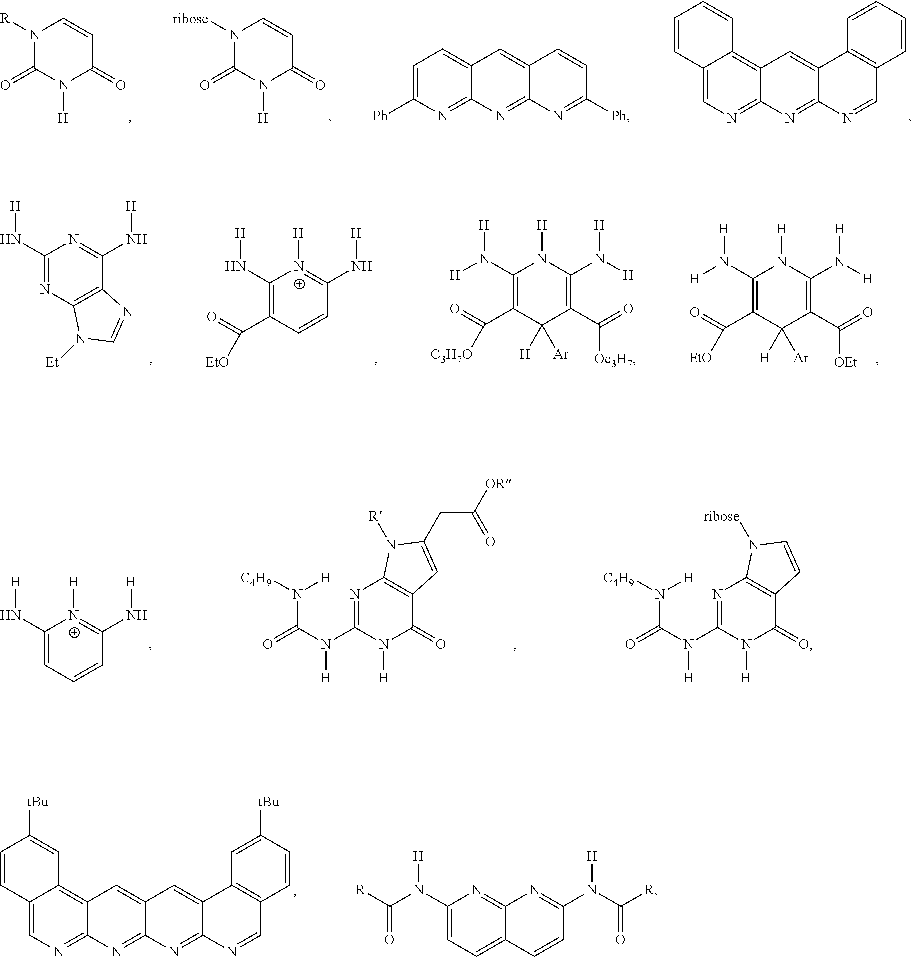

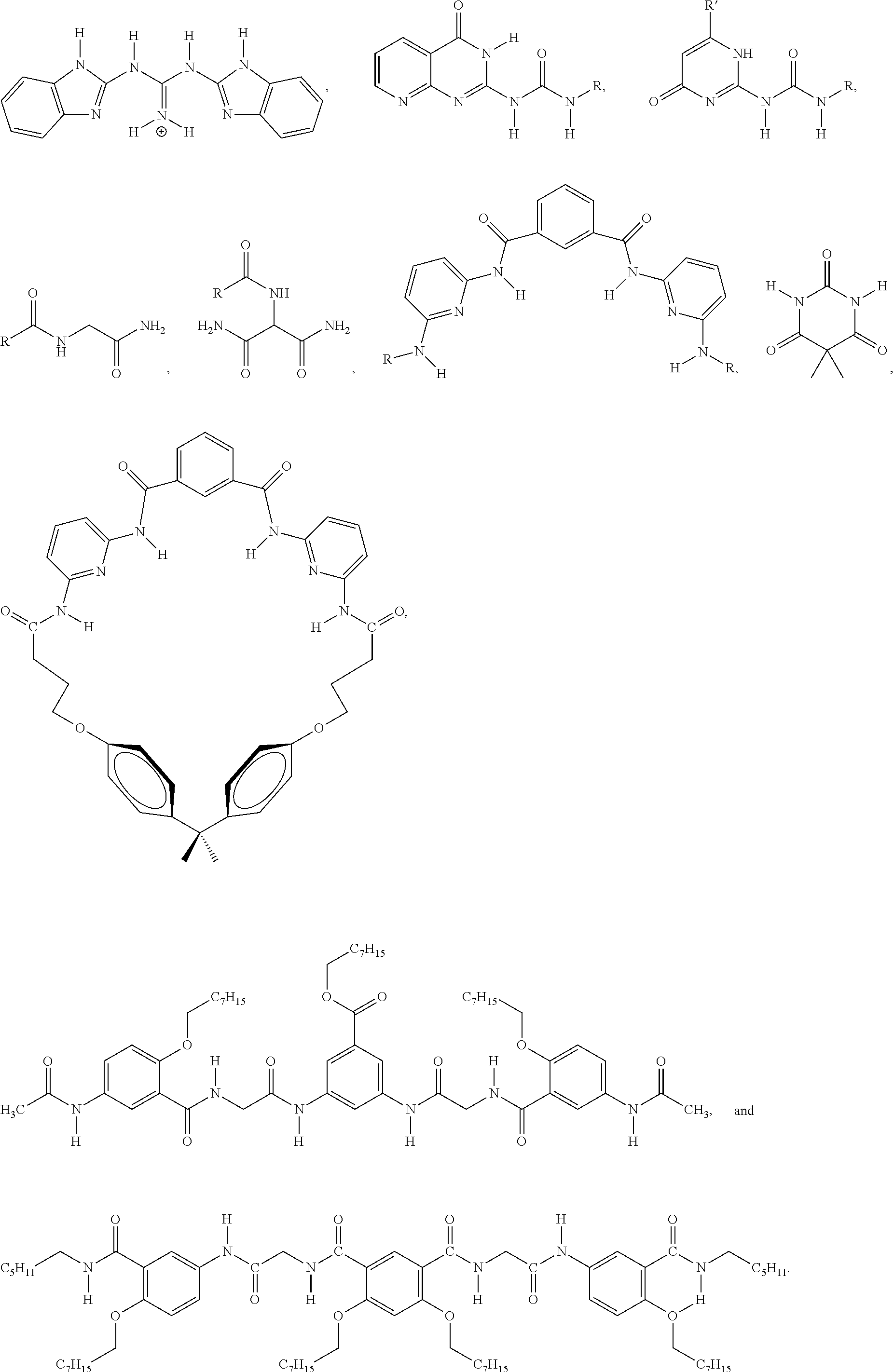

4. The polymer of claim 1, wherein the number of methylene groups of X range from about 1 to about 20.

5. The polymer of claim 1, wherein R2 and R3 are independently selected from the group consisting of H, C₁-C₁₀ alkyls, C₁-C₁₀ olefinics, aromatic, heterocyclic, halogen, ammonium, nitroxides, nitrates, nitrite amides, amines, esters, ethers, carboxylic acids, acyl chlorides, alcohols, nitriles, phosphates, phosphonates, sulfates, sulfonates, sulfide, sulfite, thiol, and combinations thereof.

6. The polymer of claim 1, wherein the polymer has an upper critical solubility temperature.

7. The polymer of claim 1, wherein the hydrogen bonding groups are complementary bonded.

8. The polymer of claim 1, wherein they hydrogen bonding groups are self-complementary bonded.

9. The polymer of claim 1, wherein the polymer is a water soluble thermoresponsive polymer.

10. The polymer of claim 1, wherein the polymer has an average molecular weight greater than 50,000.

11. The polymer of claim 1, wherein the polymer is polymerized with an organic solvent.

12. The polymer of claim 1, wherein the polymer is polymerized with an aqueous solution.

13. A polymer comprising: 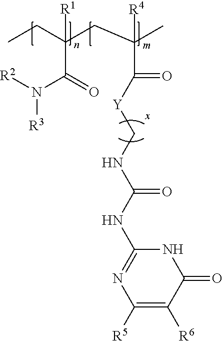
wherein:
R1 and R4 are independently selected from the group consisting of H and alkyl groups;
R2 and R3 are independently selected from the group consisting of H, alkyl, olefinic, aromatic, heterocyclic, halogen, ammonium, nitroxides, nitrates, nitrite amides, amines, esters, ethers, carboxylic acids, acyl chlorides, alcohols, nitriles, phosphates, phosphonates, sulfates, sulfonates, sulfide, sulfite, thiol, and combinations thereof;
Y is selected from the group consisting of O, N and S;
R5 and R6 are independently selected from the group consisting of alkyl, olefinic, heterocyclic, halogens, ammonium, carboxylic, amines, esters, amides and combinations thereof; and
X are methylene groups from about 0 to about 20 carbons.
